(19) United States
(12) Patent Application Publication
(10) Pub. No.: US 2026/0263205 A1
(43) Pub. Date: Sep. 10, 2026

(54) SYSTEM

(71) Applicant: SoftBank Group Corp., Tokyo (JP)

(72) Inventor: Akihiro TSUJIMOTO, Tokyo (JP)

(21) Appl. No.: 19/073,222

(22) Filed: Mar. 7, 2025

(51) Int. Cl. A61D 99/00; A01K 29/00; A61D 13/00

(52) U.S. Cl. CPC A61D 99/00; A01K 29/005; A61D 13/00

(57) ABSTRACT

The system according to the embodiment comprises a sensor unit, a collection unit, an analysis unit, a notification unit, and a referral unit. The sensor unit measures the pet's heart rate and body temperature. The collection unit collects data measured by the sensor unit. The analysis unit analyzes the data collected by the collection unit and evaluates the pet's condition. The notification unit notifies the owner if an abnormality is detected by the analysis unit. The referral unit introduces an animal hospital based on the information notified by the notification unit.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there was a problem that it was difficult to monitor the pet's condition in real- time and detect abnormalities early to take appropriate action.

### SUMMARY OF THE INVENTION

The system according to the embodiment comprises a sensor unit, a collection unit, an analysis unit, a notification unit, and a referral unit. The sensor unit measures the pet's heart rate and body temperature. The collection unit collects data measured by the sensor unit.

The analysis unit analyzes the data collected by the collection unit and evaluates the pet's condition. The notification unit notifies the owner if an abnormality is detected by the analysis unit. The referral unit introduces an animal hospital based on the information notified by the notification unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset- type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as "processor") may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, "A and/or B" means "at least one of A and B." In other words, "A and/or B" means it may be only A, only B, or a combination of A and B. Moreover, when expressing three or more items connected by "and/or," the same concept as "A and/or B" applies.

### First Embodiment

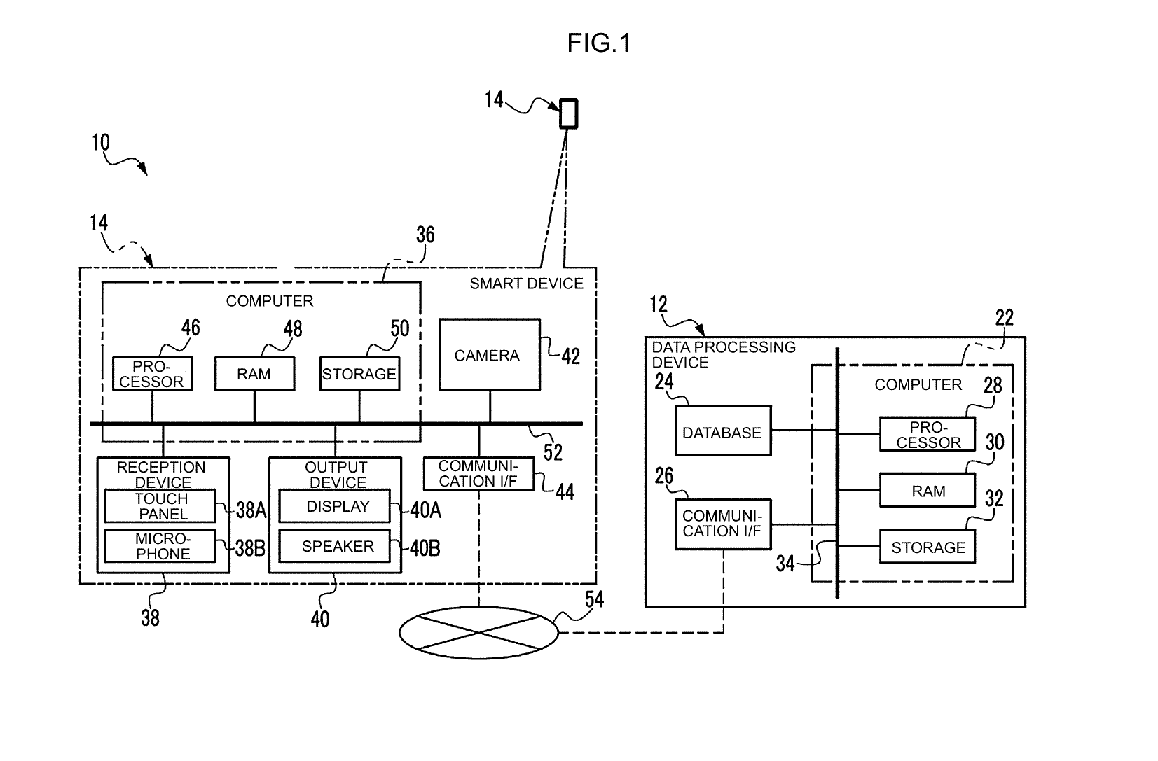

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

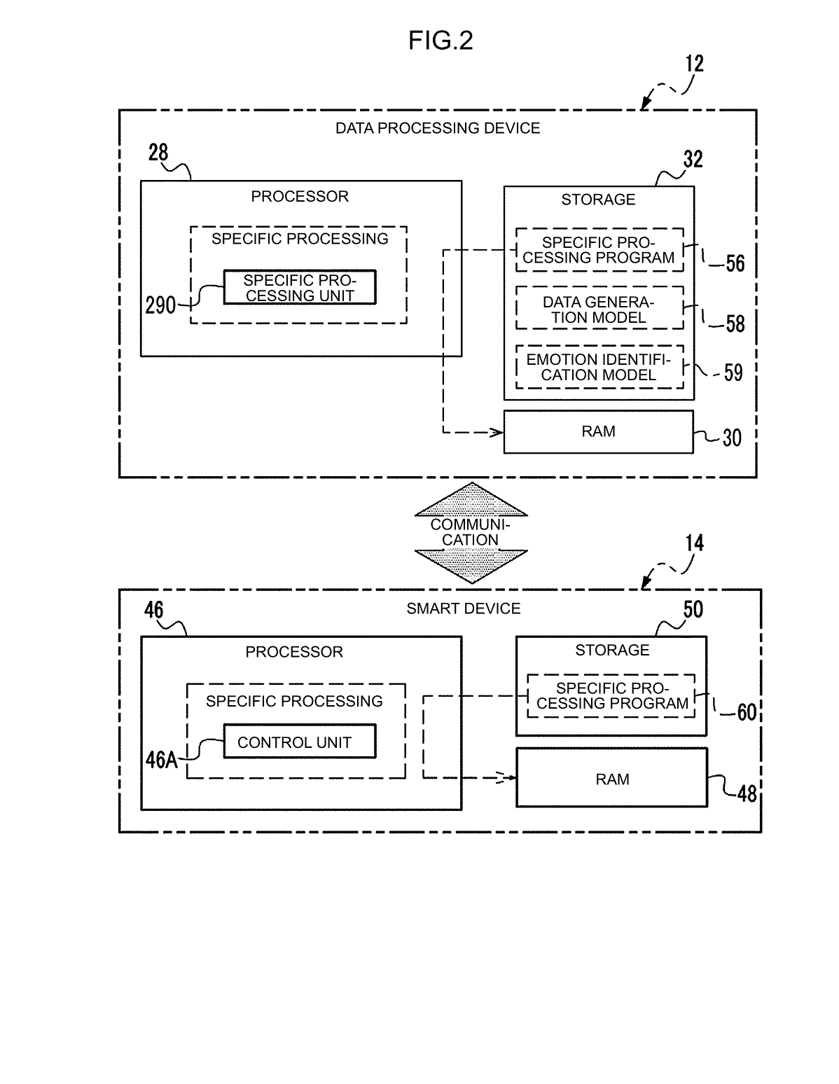

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide- Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The pet monitoring system according to the embodiment is a system that attaches sensors to the pet's cage or body to collect information such as heart rate and body temperature and monitor the pet's condition. This system measures the pet's heart rate and body temperature in real- time with sensors, and AI analyzes the data. The AI evaluates the pet's condition based on the collected data and notifies the owner when an abnormality is detected. The notification includes information on possible diseases and the introduction of the optimal animal hospital. For example, if the pet's heart rate is higher than usual, the AI evaluates the possibility of stress or illness and notifies the owner. Also, if the body temperature is abnormally high, the AI evaluates the possibility of fever and introduces an appropriate animal hospital. This system allows continuous monitoring of the pet's health and early detection of abnormalities. For example, types of sensors include a heart rate sensor attached to a collar and a body temperature sensor installed in a cage. These sensors measure the pet's heart rate and body temperature in real- time. The AI's analysis algorithm uses a machine learning algorithm for anomaly detection. It learns the normal range based on past data and determines an anomaly when data exceeding that range is detected. Regarding notification methods, real-time notification through a smartphone app is considered. Email notification is also possible. This allows the pet monitoring system to continuously monitor the pet's health and detect abnormalities early.

The pet monitoring system according to the embodiment comprises a sensor unit, a collection unit, an analysis unit, a notification unit, and a referral unit. The sensor unit measures the pet's heart rate and body temperature. For example, the sensor unit can include a heart rate sensor attached to a collar. Also, the sensor unit can include a body temperature sensor installed in a cage. The collection unit collects data measured by the sensor unit. For example, the collection unit can collect heart rate and body temperature data in real-time. The analysis unit analyzes the data collected by the collection unit and evaluates the pet's condition. For example, the analysis unit can detect abnormalities using a machine learning algorithm. The machine learning algorithm learns the normal range based on past data and determines an anomaly when data exceeding that range is detected. The notification unit notifies the owner if an abnormality is detected by the analysis unit. For example, the notification unit can notify in real-time through a smartphone app. Also, the notification unit can notify via email. The referral unit introduces the optimal animal hospital based on the information notified by the notification unit. For example, the referral unit can select the optimal animal hospital according to the pet's symptoms and introduce it to the owner. This allows the pet monitoring system according to the embodiment to monitor the pet's heart rate and body temperature in real-time, notify the owner when an abnormality is detected, and introduce the optimal animal hospital.

The sensor unit measures the pet's heart rate and body temperature. For example, the sensor unit can include a heart rate sensor attached to a collar. This heart rate sensor is worn on the pet's neck, allowing continuous monitoring of the heart rate. The heart rate sensor uses optical or electrical technology to accurately measure the heart rate and transmits the data to the collection unit in real-time. Also, the sensor unit can include a body temperature sensor installed in a cage. The body temperature sensor measures the pet's body temperature when the pet is in the cage and detects changes in the environment or the pet's condition. The body temperature sensor can measure the temperature non-contact using infrared technology, allowing data collection without stressing the pet. Furthermore, the sensor unit can include accelerometers and gyroscopes to monitor the pet's activity level and sleep patterns. This allows detailed understanding of the pet's activity and rest state, enabling comprehensive evaluation of health status. By combining these various sensors, the sensor unit can comprehensively monitor the pet's health and contribute to early detection of abnormalities.

The collection unit collects data measured by the sensor unit. For example, the collection unit can collect heart rate and body temperature data in real-time. The collection unit receives data transmitted from the sensor unit and stores it in a central database. The collection unit is equipped with high-speed communication protocols and large-capacity storage to efficiently receive and store data. Furthermore, the collection unit has functions to detect and request retransmission of duplicate or missing data to ensure data integrity and reliability. The collection unit centrally manages data from the sensor unit, making it accessible to the analysis unit and notification unit. For example, the collection unit assigns timestamps to data and records the occurrence time of each data point, managing it as time-series data. This allows the analysis unit to compare past and current data for anomaly detection and trend analysis. The collection unit can flexibly set the frequency and range of data collection, achieving optimal data collection according to the pet's condition and environment.

The analysis unit analyzes the data collected by the collection unit and evaluates the pet's condition. For example, the analysis unit can detect abnormalities using a machine learning algorithm. The machine learning algorithm learns the normal range based on past data and determines an anomaly when data exceeding that range is detected. Specifically, the analysis unit performs time-series analysis of heart rate and body temperature data to detect abnormal patterns or sudden changes. For example, if the heart rate suddenly rises or the body temperature is abnormally high, the analysis unit determines this as an anomaly and notifies the notification unit. Also, the analysis unit can analyze the pet's activity level and sleep patterns to perform a comprehensive evaluation of health status. For example, if the pet's activity level is lower than usual or sleep time is short, the analysis unit considers this a sign of abnormality and alerts the owner. Furthermore, the analysis unit can provide information useful for long-term health management and prevention, not just anomaly detection. For example, the analysis unit analyzes trends in the pet's health status and predicts future risks. This allows the owner to take early measures and provide appropriate care to maintain the pet's health.

The notification unit notifies the owner if an abnormality is detected by the analysis unit. For example, the notification unit can notify in real-time through a smartphone app. The notification unit receives anomaly detection information from the analysis unit and is equipped with an interface to quickly notify the owner. The notification unit uses the push notification function of the smartphone to immediately send a notification to the owner when an anomaly is detected. Also, the notification unit can notify via email. Email notifications can include detailed information and serve as a record for the owner to check later. Furthermore, the notification unit can use voice calls or SMS to ensure delivery to the owner in emergencies. The notification unit can customize the notification content and select the appropriate notification method according to the type and urgency of the anomaly. For example, for minor anomalies, only push notifications are sent, while for major anomalies, voice calls or SMS are also used. This allows the notification unit to quickly and reliably inform the owner of anomalies and prompt appropriate action.

The referral unit introduces the optimal animal hospital based on the information notified by the notification unit. For example, the referral unit can select the optimal animal hospital according to the pet's symptoms and introduce it to the owner. The referral unit has a database of animal hospitals and manages information such as each hospital's specialties, consultation hours, and location. The referral unit searches for the optimal animal hospital based on the pet's symptoms and condition provided by the analysis unit and introduces it to the owner. For example, if the pet's heart rate is abnormally high, a heart specialist animal hospital is prioritized for introduction. Also, the referral unit can consider the owner's current location and means of transportation to select the most accessible hospital. The referral unit provides detailed information about the introduced animal hospital to the owner and guides them through reservation procedures and emergency contacts. Furthermore, the referral unit can continuously improve referral accuracy based on past referral history and owner feedback. This allows the referral unit to provide quick and appropriate medical support to the owner and assist in managing the pet's health.

The sensor unit can include a heart rate sensor attached to a collar. The heart rate sensor, for example, is attached to the pet's collar. The heart rate sensor can measure the pet's heart rate in real-time. For example, the heart rate sensor can use an optical sensor to measure the heart rate. Also, the heart rate sensor can use an electrical sensor to measure the heart rate. Furthermore, the heart rate sensor can use an ultrasonic sensor to measure the heart rate. This allows the heart rate sensor attached to the collar to accurately measure the pet's heart rate.

The sensor unit can include a body temperature sensor installed in a cage. The body temperature sensor, for example, is installed in the pet's cage. The body temperature sensor can measure the pet's body temperature in real-time. For example, the body temperature sensor can use an infrared sensor to measure the temperature. Also, the body temperature sensor can use a contact sensor to measure the temperature. Furthermore, the body temperature sensor can use a thermistor to measure the temperature.

This allows the body temperature sensor installed in the cage to accurately measure the pet's body temperature.

The analysis unit can detect abnormalities using a machine learning algorithm. The machine learning algorithm, for example, analyzes the pet's heart rate and body temperature data. The machine learning algorithm learns the normal range based on past data and determines an anomaly when data exceeding that range is detected. For example, the machine learning algorithm can use K-means clustering to detect anomalies. Also, the machine learning algorithm can use a support vector machine (SVM) to detect anomalies. Furthermore, the machine learning algorithm can use deep learning to detect anomalies. This allows the use of a machine learning algorithm to improve the accuracy of anomaly detection.

The notification unit can notify in real-time through a smartphone app. The notification unit, for example, notifies the owner through a smartphone app. The notification unit can notify the owner in real-time when an anomaly is detected. For example, the notification unit can use push notifications to notify the owner. Also, the notification unit can use the in-app notification function to notify the owner. Furthermore, the notification unit can display anomaly information on the app's dashboard. This allows real-time notification through a smartphone app, enabling the owner to respond quickly.

The notification unit can notify via email. The notification unit, for example, notifies the owner via email. The notification unit can notify the owner via email when an anomaly is detected. For example, the notification unit can automatically send an email containing anomaly information. Also, the notification unit can customize the email content. Furthermore, the notification unit can set the timing of email sending. This allows notification via email, making it easier for the owner to check anomalies.

The sensor unit can adjust the measurement frequency of heart rate and body temperature based on the pet's behavior data. The sensor unit, for example, collects the pet's behavior data and adjusts the measurement frequency of heart rate and body temperature. The sensor unit can estimate the pet's emotions and adjust the measurement frequency based on emotions. For example, if the pet is relaxed, the measurement frequency of heart rate and body temperature is set low. Also, if the pet is excited, the measurement frequency of heart rate and body temperature is set high. Furthermore, if the pet is stressed, the measurement frequency of heart rate and body temperature is set to medium. This allows adjustment of the measurement frequency according to the pet's emotions, enabling more accurate data collection.

The sensor unit can add an accelerometer to measure the pet's activity level and evaluate the condition by combining activity data with heart rate and body temperature data. The sensor unit, for example, includes an accelerometer to measure the pet's activity level. The accelerometer can measure the pet's movements in real-time. The sensor unit evaluates the condition by combining activity data with heart rate and body temperature data. For example, if the pet is actively moving, the heart rate and body temperature data are combined with activity data for evaluation. Also, if the pet is stationary, the heart rate and body temperature data are combined with activity data for evaluation. Furthermore, if the pet is sleeping, the heart rate and body temperature data are combined with activity data for evaluation. This allows more accurate evaluation of the pet's condition by combining activity data.

The sensor unit can add a sensor to measure the pet's respiratory rate and evaluate the condition by combining respiratory rate data with heart rate and body temperature data. The sensor unit, for example, includes a sensor to measure the pet's respiratory rate. The respiratory rate sensor can measure the pet's respiratory rate in real-time.

The sensor unit evaluates the condition by combining respiratory rate data with heart rate and body temperature data. For example, if the pet's respiratory rate is higher than usual, the heart rate and body temperature data are combined for evaluation. Also, if the pet's respiratory rate is lower than usual, the heart rate and body temperature data are combined for evaluation. Furthermore, if the pet's respiratory rate is irregular, the heart rate and body temperature data are combined for evaluation. This allows more accurate evaluation of the pet's condition by combining respiratory rate data.

The sensor unit can adjust the sensitivity of the sensors based on the pet's behavior data. The sensor unit, for example, collects the pet's behavior data and adjusts the sensitivity of the sensors. The sensor unit can estimate the pet's emotions and adjust the sensitivity of the sensors based on emotions. For example, if the pet is relaxed, the sensitivity of the sensors is set low. Also, if the pet is excited, the sensitivity of the sensors is set high. Furthermore, if the pet is stressed, the sensitivity of the sensors is set to medium. This allows adjustment of the sensor sensitivity according to the pet's emotions, enabling more accurate data collection.

The sensor unit can add a sensor to measure the pet's food intake and evaluate the condition by combining food intake data with heart rate and body temperature data. The sensor unit, for example, includes a sensor to measure the pet's food intake. The food intake sensor can measure the pet's food intake in real-time. The sensor unit evaluates the condition by combining food intake data with heart rate and body temperature data. For example, if the pet's food intake is more than usual, the heart rate and body temperature data are combined for evaluation. Also, if the pet's food intake is less than usual, the heart rate and body temperature data are combined for evaluation. Furthermore, if the pet's food intake is irregular, the heart rate and body temperature data are combined for evaluation. This allows more accurate evaluation of the pet's condition by combining food intake data.

The sensor unit can add a sensor to measure the pet's sleep state and evaluate the condition by combining sleep data with heart rate and body temperature data. The sensor unit, for example, includes a sensor to measure the pet's sleep state. The sleep state sensor can measure the pet's sleep state in real-time. The sensor unit evaluates the condition by combining sleep data with heart rate and body temperature data. For example, if the pet's sleep time is longer than usual, the heart rate and body temperature data are combined for evaluation. Also, if the pet's sleep time is shorter than usual, the heart rate and body temperature data are combined for evaluation. Furthermore, if the pet's sleep is irregular, the heart rate and body temperature data are combined for evaluation. This allows more accurate evaluation of the pet's condition by combining sleep data.

The collection unit can adjust the timing of data collection based on the pet's behavior data. The collection unit, for example, collects the pet's behavior data and adjusts the timing of data collection. The collection unit can estimate the pet's emotions and adjust the timing of data collection based on emotions. For example, if the pet is relaxed, the frequency of data collection is set low. Also, if the pet is excited, the frequency of data collection is set high. Furthermore, if the pet is stressed, the frequency of data collection is set to medium. This allows adjustment of the timing of data collection according to the pet's emotions, enabling more accurate data collection.

The collection unit can add a function to evaluate the reliability of data and filter out unreliable data. The collection unit, for example, evaluates the reliability of data and filters out unreliable data. The collection unit can automatically exclude unreliable data by evaluating the reliability of data. For example, the collection unit evaluates the reliability of data and collects only reliable data. Also, the collection unit can manually check unreliable data by evaluating the reliability of data. This allows filtering out unreliable data, improving data accuracy.

The collection unit can add a function to automatically detect and exclude outliers in the data. The collection unit, for example, automatically detects and excludes outliers in the data. The collection unit can automatically detect and exclude outliers in the data. For example, the collection unit automatically detects outliers in the data and manually checks them. Also, the collection unit can automatically detect and correct outliers in the data. This allows exclusion of outliers, improving data accuracy.

The collection unit can determine the priority of data to be collected based on the pet's behavior data. The collection unit, for example, collects the pet's behavior data and determines the priority of data to be collected. The collection unit can estimate the pet's emotions and determine the priority of data to be collected based on emotions. For example, if the pet is relaxed, heart rate data is prioritized for collection. Also, if the pet is excited, body temperature data is prioritized for collection. Furthermore, if the pet is stressed, respiratory rate data is prioritized for collection. This allows determination of data priority according to the pet's emotions, enabling prioritized collection of important data.

The collection unit can add a function to set the data retention period and automatically delete old data. The collection unit, for example, sets the data retention period and automatically deletes old data. The collection unit can automatically delete data that has exceeded the retention period by setting the data retention period. For example, the collection unit sets the data retention period and manually deletes data that has exceeded the retention period. Also, the collection unit can archive data that has exceeded the retention period by setting the data retention period. This allows automatic deletion of old data, making data management easier.

The collection unit can add a backup function to prevent data loss. The collection unit, for example, regularly backs up data to prevent data loss. The collection unit can regularly back up data to prevent data loss. For example, the collection unit manually backs up data to prevent data loss. Also, the collection unit can save data backups to the cloud to prevent data loss. This allows prevention of data loss through the backup function.

The analysis unit can adjust the analysis algorithm based on the pet's behavior data. The analysis unit, for example, collects the pet's behavior data and adjusts the analysis algorithm. The analysis unit can estimate the pet's emotions and adjust the analysis algorithm based on emotions. For example, if the pet is relaxed, the sensitivity of the analysis algorithm is set low. Also, if the pet is excited, the sensitivity of the analysis algorithm is set high. Furthermore, if the pet is stressed, the sensitivity of the analysis algorithm is set to medium. This allows adjustment of the analysis algorithm according to the pet's emotions, improving analysis accuracy.

The analysis unit can add a data preprocessing function to improve the accuracy of anomaly detection. The analysis unit, for example, adds a data preprocessing function to improve the accuracy of anomaly detection. The analysis unit can add a data preprocessing function to improve the accuracy of anomaly detection. For example, the analysis unit adds a data preprocessing function to remove noise from the data. Also, the analysis unit can add a data preprocessing function to complement missing values in the data. This allows improvement of anomaly detection accuracy by adding a data preprocessing function.

The analysis unit can add a function to visualize the results of anomaly detection and display them in an easy- to-understand manner for the owner. The analysis unit, for example, displays the results of anomaly detection in a graph to make it easy for the owner to understand. The analysis unit can display the results of anomaly detection in a graph to make it easy for the owner to understand. For example, the analysis unit displays the results of anomaly detection in a chart to make it easy for the owner to understand. Also, the analysis unit can display the results of anomaly detection in text to make it easy for the owner to understand. This allows visualization of anomaly detection results, making it easier for the owner to understand anomalies.

The analysis unit can adjust the display method of analysis results based on the pet's behavior data. The analysis unit, for example, collects the pet's behavior data and adjusts the display method of analysis results. The analysis unit can estimate the pet's emotions and adjust the display method of analysis results based on emotions. For example, if the pet is relaxed, detailed analysis results are displayed. Also, if the pet is excited, concise analysis results are displayed. Furthermore, if the pet is stressed, visually easy-to- understand analysis results are displayed. This allows adjustment of the display method of analysis results according to the pet's emotions, making it easier for the owner to understand the analysis results.

The analysis unit can add a function to compare the results of anomaly detection with data from other pets to evaluate the degree of anomaly. The analysis unit, for example, compares the results of anomaly detection with data from other pets to evaluate the degree of anomaly. The analysis unit can compare the results of anomaly detection with data from other pets to evaluate the degree of anomaly. For example, the analysis unit compares the results of anomaly detection with data from other pets to identify the cause of the anomaly. Also, the analysis unit can compare the results of anomaly detection with data from other pets to propose measures for the anomaly. This allows easier evaluation of the degree of anomaly by comparing with data from other pets.

The analysis unit can add a function to compare the results of anomaly detection with past data to analyze trends in anomalies. The analysis unit, for example, compares the results of anomaly detection with past data to analyze trends in anomalies. The analysis unit can compare the results of anomaly detection with past data to analyze trends in anomalies. For example, the analysis unit compares the results of anomaly detection with past data to identify the cause of the anomaly. Also, the analysis unit can compare the results of anomaly detection with past data to propose measures for the anomaly. This allows easier analysis of trends in anomalies by comparing with past data.

The notification unit can adjust the content of notifications based on the pet's behavior data. The notification unit, for example, collects the pet's behavior data and adjusts the content of notifications. The notification unit can estimate the pet's emotions and adjust the content of notifications based on emotions. For example, if the pet is relaxed, detailed notification content is provided. Also, if the pet is excited, concise notification content is provided. Furthermore, if the pet is stressed, visually easy-to-understand notification content is provided. This allows adjustment of notification content according to the pet's emotions, making it easier for the owner to understand the notification content.

The notification unit can add a function to set the urgency of notifications and change the notification method according to the urgency. The notification unit, for example, sets the urgency of notifications and changes the notification method according to the urgency. The notification unit can set the urgency of notifications and change the notification method according to the urgency. For example, if the urgency is high, the notification unit uses smartphone push notifications for immediate notification. Also, if the urgency is medium, the notification unit can notify via email. Furthermore, if the urgency is low, the notification unit can display notifications in the app's notification center. This allows changing the notification method according to the urgency, enabling the owner to respond quickly.

The notification unit can add a function to save notification history and allow reference to past notification content. The notification unit, for example, saves notification history and allows reference to past notification content. The notification unit can save notification history and allow reference to past notification content. For example, the notification unit saves notification history and displays past notification content in a list. Also, the notification unit can save notification history and allow searching for specific notification content. Furthermore, the notification unit can save notification history and display notification content in chronological order. This allows easier reference to past notification content by saving notification history.

The notification unit can adjust the timing of notifications based on the pet's behavior data. The notification unit, for example, collects the pet's behavior data and adjusts the timing of notifications. The notification unit can estimate the pet's emotions and adjust the timing of notifications based on emotions. For example, if the pet is relaxed, the timing of notifications is delayed. Also, if the pet is excited, the timing of notifications is advanced. Furthermore, if the pet is stressed, the timing of notifications is set to medium. This allows adjustment of the timing of notifications according to the pet's emotions, enabling the owner to receive notifications at the appropriate timing.

The notification unit can add a customization function to change the notification content according to the owner's preferences. The notification unit, for example, adds a customization function to change the notification content according to the owner's preferences. The notification unit can add a customization function to change the notification content according to the owner's preferences. For example, if the owner prefers detailed notifications, the notification unit provides detailed notification content. Also, if the owner prefers concise notifications, the notification unit provides concise notification content. Furthermore, if the owner prefers visual notifications, the notification unit provides notification content including graphs and charts. This allows the owner to receive notification content according to their preferences through the customization function.

The notification unit can add a function to select the language of notifications and provide notifications in multiple languages. The notification unit, for example, adds a function to select the language of notifications and provides notifications in multiple languages. The notification unit can add a function to select the language of notifications and provide notifications in multiple languages. For example, the notification unit automatically sets the notification language based on the language settings of the owner's device. Also, if the owner uses multiple languages, the notification unit can provide a language switching function. Furthermore, if the owner selects a specific language, the notification unit provides notifications in that language. This allows the owner to receive notifications in the desired language through the function to select the notification language.

The referral unit can adjust the criteria for selecting animal hospitals to be introduced based on the pet's behavior data. The referral unit, for example, collects the pet's behavior data and adjusts the criteria for selecting animal hospitals to be introduced. The referral unit can estimate the pet's emotions and adjust the criteria for selecting animal hospitals to be introduced based on emotions. For example, if the pet is relaxed, a regular animal hospital is introduced. Also, if the pet is excited, an animal hospital capable of emergency response is introduced. Furthermore, if the pet is stressed, an animal hospital specializing in stress reduction is introduced. This allows adjustment of the criteria for selecting animal hospitals according to the pet's emotions, enabling the introduction of the optimal animal hospital.

The referral unit can add a function to collect evaluation information of animal hospitals and prioritize the introduction of highly rated hospitals. The referral unit, for example, collects evaluation information of animal hospitals and prioritizes the introduction of highly rated hospitals. The referral unit can collect evaluation information of animal hospitals and prioritize the introduction of highly rated hospitals. For example, the referral unit collects evaluation information of animal hospitals and prioritizes the introduction of highly rated hospitals. Also, the referral unit can collect evaluation information of animal hospitals and exclude low-rated hospitals. Furthermore, the referral unit can collect evaluation information of animal hospitals and display highly rated hospitals in a ranking format. This allows prioritization of highly rated hospitals for introduction, making it easier for the owner to choose a reliable hospital.

The referral unit can add a function to select the optimal hospital based on the medical departments and specialties of animal hospitals. The referral unit, for example, selects the optimal hospital based on the medical departments and specialties of animal hospitals. The referral unit can select the optimal hospital based on the medical departments and specialties of animal hospitals. For example, the referral unit selects the optimal hospital based on the medical departments of animal hospitals. Also, the referral unit can select the optimal hospital based on the specialties of animal hospitals. Furthermore, the referral unit can combine the medical departments and specialties of animal hospitals to select the optimal hospital. This allows selection of the optimal hospital based on medical departments and specialties, enabling the introduction of a hospital suitable for the pet's symptoms.

The referral unit can determine the priority of animal hospitals to be introduced based on the pet's behavior data. The referral unit, for example, collects the pet's behavior data and determines the priority of animal hospitals to be introduced. The referral unit can estimate the pet's emotions and determine the priority of animal hospitals to be introduced based on emotions. For example, if the pet is relaxed, a regular animal hospital is prioritized for introduction. Also, if the pet is excited, an animal hospital capable of emergency response is prioritized for introduction. Furthermore, if the pet is stressed, an animal hospital specializing in stress reduction is prioritized for introduction. This allows determination of the priority of animal hospitals according to the pet's emotions, enabling quick introduction of the optimal hospital.

The referral unit can add a function to check the reservation status of animal hospitals and introduce hospitals that are easy to book. The referral unit, for example, checks the reservation status of animal hospitals and introduces hospitals that are easy to book. The referral unit can check the reservation status of animal hospitals and introduce hospitals that are easy to book. For example, the referral unit checks the reservation status of animal hospitals and introduces hospitals that are easy to book. Also, the referral unit can check the reservation status of animal hospitals and exclude hospitals that are difficult to book. Furthermore, the referral unit can check the reservation status of animal hospitals and display hospitals that are easy to book in a ranking format. This allows introduction of hospitals that are easy to book, enabling the owner to quickly make a reservation.

The referral unit can add a function to provide location information of animal hospitals and introduce hospitals close to the owner's residence. The referral unit, for example, provides location information of animal hospitals and introduces hospitals close to the owner's residence. The referral unit can provide location information of animal hospitals and introduce hospitals close to the owner's residence. For example, the referral unit provides location information of animal hospitals and introduces hospitals close to the owner's residence. Also, the referral unit can provide location information of animal hospitals and exclude hospitals far from the owner's residence. Furthermore, the referral unit can provide location information of animal hospitals and display hospitals close to the owner's residence in a ranking format. This allows introduction of hospitals close to the owner's residence, enabling the owner to quickly access the hospital.

The system according to the embodiment is not limited to the examples described above, and various modifications are possible, for example, as follows.

The pet monitoring system can further include a sensor to measure the pet's food intake. The food intake sensor measures the pet's food intake in real-time and sends the data to the collection unit. The analysis unit can evaluate the pet's condition by combining food intake data with heart rate and body temperature data. For example, if the pet's food intake is more than usual, the heart rate and body temperature data are combined for evaluation. Also, if the pet's food intake is less than usual, the heart rate and body temperature data are combined for evaluation. Furthermore, if the pet's food intake is irregular, the heart rate and body temperature data are combined for evaluation. This allows more accurate evaluation of the pet's condition by combining food intake data.

The pet monitoring system can further include a sensor to measure the pet's sleep state. The sleep state sensor measures the pet's sleep state in real-time and sends the data to the collection unit. The analysis unit can evaluate the pet's condition by combining sleep data with heart rate and body temperature data. For example, if the pet's sleep time is longer than usual, the heart rate and body temperature data are combined for evaluation. Also, if the pet's sleep time is shorter than usual, the heart rate and body temperature data are combined for evaluation. Furthermore, if the pet's sleep is irregular, the heart rate and body temperature data are combined for evaluation. This allows more accurate evaluation of the pet's condition by combining sleep data.

The pet monitoring system can further include a sensor to measure the pet's respiratory rate. The respiratory rate sensor measures the pet's respiratory rate in real-time and sends the data to the collection unit. The analysis unit can evaluate the pet's condition by combining respiratory rate data with heart rate and body temperature data. For example, if the pet's respiratory rate is higher than usual, the heart rate and body temperature data are combined for evaluation. Also, if the pet's respiratory rate is lower than usual, the heart rate and body temperature data are combined for evaluation. Furthermore, if the pet's respiratory rate is irregular, the heart rate and body temperature data are combined for evaluation. This allows more accurate evaluation of the pet's condition by combining respiratory rate data.

The following is a brief explanation of the process flow in Example 1 of the Embodiment.

Step 1: The sensor unit measures the pet's heart rate and body temperature. For example, the sensor unit can include a heart rate sensor attached to a collar and a body temperature sensor installed in a cage.

Step 2: The collection unit collects data measured by the sensor unit. For example, the collection unit can collect heart rate and body temperature data in real-time.

Step 3: The analysis unit analyzes the data collected by the collection unit and evaluates the pet's condition. For example, the analysis unit can detect abnormalities using a machine learning algorithm. The machine learning algorithm learns the normal range based on past data and determines an anomaly when data exceeding that range is detected.

Step 4: The notification unit notifies the owner if an abnormality is detected by the analysis unit. For example, the notification unit can notify in real-time through a smartphone app. Also, the notification unit can notify via email.

Step 5: The referral unit introduces the optimal animal hospital based on the information notified by the notification unit. For example, the referral unit can select the optimal animal hospital according to the pet's symptoms and introduce it to the owner. [Example 2 of the Embodiment]

### Example 2 of the Embodiment

The pet monitoring system according to the embodiment is a system that attaches sensors to the pet's cage or body to collect information such as heart rate and body temperature and monitor the pet's condition. This system measures the pet's heart rate and body temperature in real- time with sensors, and AI analyzes the data. The AI evaluates the pet's condition based on the collected data and notifies the owner when an abnormality is detected. The notification includes information on possible diseases and the introduction of the optimal animal hospital. For example, if the pet's heart rate is higher than usual, the AI evaluates the possibility of stress or illness and notifies the owner. Also, if the body temperature is abnormally high, the AI evaluates the possibility of fever and introduces an appropriate animal hospital. This system allows continuous monitoring of the pet's health and early detection of abnormalities. For example, types of sensors include a heart rate sensor attached to a collar and a body temperature sensor installed in a cage. These sensors measure the pet's heart rate and body temperature in real- time. The AI's analysis algorithm uses a machine learning algorithm for anomaly detection. It learns the normal range based on past data and determines an anomaly when data exceeding that range is detected. Regarding notification methods, real-time notification through a smartphone app is considered. Email notification is also possible. This allows the pet monitoring system to continuously monitor the pet's health and detect abnormalities early.

The pet monitoring system according to the embodiment comprises a sensor unit, a collection unit, an analysis unit, a notification unit, and a referral unit. The sensor unit measures the pet's heart rate and body temperature. For example, the sensor unit can include a heart rate sensor attached to a collar. Also, the sensor unit can include a body temperature sensor installed in a cage. The collection unit collects data measured by the sensor unit. For example, the collection unit can collect heart rate and body temperature data in real-time. The analysis unit analyzes the data collected by the collection unit and evaluates the pet's condition. For example, the analysis unit can detect abnormalities using a machine learning algorithm. The machine learning algorithm learns the normal range based on past data and determines an anomaly when data exceeding that range is detected. The notification unit notifies the owner if an abnormality is detected by the analysis unit. For example, the notification unit can notify in real-time through a smartphone app. Also, the notification unit can notify via email. The referral unit introduces the optimal animal hospital based on the information notified by the notification unit. For example, the referral unit can select the optimal animal hospital according to the pet's symptoms and introduce it to the owner. This allows the pet monitoring system according to the embodiment to monitor the pet's heart rate and body temperature in real-time, notify the owner when an abnormality is detected, and introduce the optimal animal hospital.

The sensor unit measures the pet's heart rate and body temperature. For example, the sensor unit can include a heart rate sensor attached to a collar. This heart rate sensor is worn on the pet's neck, allowing continuous monitoring of the heart rate. The heart rate sensor uses optical or electrical technology to accurately measure the heart rate and transmits the data to the collection unit in real-time. Also, the sensor unit can include a body temperature sensor installed in a cage. The body temperature sensor measures the pet's body temperature when the pet is in the cage and detects changes in the environment or the pet's condition. The body temperature sensor can measure the temperature non-contact using infrared technology, allowing data collection without stressing the pet. Furthermore, the sensor unit can include accelerometers and gyroscopes to monitor the pet's activity level and sleep patterns. This allows detailed understanding of the pet's activity and rest state, enabling comprehensive evaluation of health status. By combining these various sensors, the sensor unit can comprehensively monitor the pet's health and contribute to early detection of abnormalities.

The collection unit collects data measured by the sensor unit. For example, the collection unit can collect heart rate and body temperature data in real-time. The collection unit receives data transmitted from the sensor unit and stores it in a central database. The collection unit is equipped with high-speed communication protocols and large-capacity storage to efficiently receive and store data. Furthermore, the collection unit has functions to detect and request retransmission of duplicate or missing data to ensure data integrity and reliability. The collection unit centrally manages data from the sensor unit, making it accessible to the analysis unit and notification unit. For example, the collection unit assigns timestamps to data and records the occurrence time of each data point, managing it as time-series data. This allows the analysis unit to compare past and current data for anomaly detection and trend analysis. The collection unit can flexibly set the frequency and range of data collection, achieving optimal data collection according to the pet's condition and environment.

The analysis unit analyzes the data collected by the collection unit and evaluates the pet's condition. For example, the analysis unit can detect abnormalities using a machine learning algorithm. The machine learning algorithm learns the normal range based on past data and determines an anomaly when data exceeding that range is detected. Specifically, the analysis unit performs time-series analysis of heart rate and body temperature data to detect abnormal patterns or sudden changes. For example, if the heart rate suddenly rises or the body temperature is abnormally high, the analysis unit determines this as an anomaly and notifies the notification unit. Also, the analysis unit can analyze the pet's activity level and sleep patterns to perform a comprehensive evaluation of health status. For example, if the pet's activity level is lower than usual or sleep time is short, the analysis unit considers this a sign of abnormality and alerts the owner. Furthermore, the analysis unit can provide information useful for long-term health management and prevention, not just anomaly detection. For example, the analysis unit analyzes trends in the pet's health status and predicts future risks. This allows the owner to take early measures and provide appropriate care to maintain the pet's health.

The notification unit notifies the owner if an abnormality is detected by the analysis unit. For example, the notification unit can notify in real-time through a smartphone app. The notification unit receives anomaly detection information from the analysis unit and is equipped with an interface to quickly notify the owner. The notification unit uses the push notification function of the smartphone to immediately send a notification to the owner when an anomaly is detected. Also, the notification unit can notify via email. Email notifications can include detailed information and serve as a record for the owner to check later. Furthermore, the notification unit can use voice calls or SMS to ensure delivery to the owner in emergencies. The notification unit can customize the notification content and select the appropriate notification method according to the type and urgency of the anomaly. For example, for minor anomalies, only push notifications are sent, while for major anomalies, voice calls or SMS are also used. This allows the notification unit to quickly and reliably inform the owner of anomalies and prompt appropriate action.

The referral unit introduces the optimal animal hospital based on the information notified by the notification unit. For example, the referral unit can select the optimal animal hospital according to the pet's symptoms and introduce it to the owner. The referral unit has a database of animal hospitals and manages information such as each hospital's specialties, consultation hours, and location. The referral unit searches for the optimal animal hospital based on the pet's symptoms and condition provided by the analysis unit and introduces it to the owner. For example, if the pet's heart rate is abnormally high, a heart specialist animal hospital is prioritized for introduction. Also, the referral unit can consider the owner's current location and means of transportation to select the most accessible hospital. The referral unit provides detailed information about the introduced animal hospital to the owner and guides them through reservation procedures and emergency contacts. Furthermore, the referral unit can continuously improve referral accuracy based on past referral history and owner feedback. This allows the referral unit to provide quick and appropriate medical support to the owner and assist in managing the pet's health.

The sensor unit can include a heart rate sensor attached to a collar. The heart rate sensor, for example, is attached to the pet's collar. The heart rate sensor can measure the pet's heart rate in real-time. For example, the heart rate sensor can use an optical sensor to measure the heart rate. Also, the heart rate sensor can use an electrical sensor to measure the heart rate. Furthermore, the heart rate sensor can use an ultrasonic sensor to measure the heart rate. This allows the heart rate sensor attached to the collar to accurately measure the pet's heart rate.

The sensor unit can include a body temperature sensor installed in a cage. The body temperature sensor, for example, is installed in the pet's cage. The body temperature sensor can measure the pet's body temperature in real-time. For example, the body temperature sensor can use an infrared sensor to measure the temperature. Also, the body temperature sensor can use a contact sensor to measure the temperature. Furthermore, the body temperature sensor can use a thermistor to measure the temperature.

This allows the body temperature sensor installed in the cage to accurately measure the pet's body temperature.

The analysis unit can detect abnormalities using a machine learning algorithm. The machine learning algorithm, for example, analyzes the pet's heart rate and body temperature data. The machine learning algorithm learns the normal range based on past data and determines an anomaly when data exceeding that range is detected. For example, the machine learning algorithm can use K-means clustering to detect anomalies. Also, the machine learning algorithm can use a support vector machine (SVM) to detect anomalies. Furthermore, the machine learning algorithm can use deep learning to detect anomalies. This allows the use of a machine learning algorithm to improve the accuracy of anomaly detection.

The notification unit can notify in real-time through a smartphone app. The notification unit, for example, notifies the owner through a smartphone app. The notification unit can notify the owner in real-time when an anomaly is detected. For example, the notification unit can use push notifications to notify the owner. Also, the notification unit can use the in-app notification function to notify the owner. Furthermore, the notification unit can display anomaly information on the app's dashboard. This allows real-time notification through a smartphone app, enabling the owner to respond quickly.

The notification unit can notify via email. The notification unit, for example, notifies the owner via email. The notification unit can notify the owner via email when an anomaly is detected. For example, the notification unit can automatically send an email containing anomaly information. Also, the notification unit can customize the email content. Furthermore, the notification unit can set the timing of email sending. This allows notification via email, making it easier for the owner to check anomalies.

The sensor unit can adjust the measurement frequency of heart rate and body temperature based on the pet's behavior data. The sensor unit, for example, collects the pet's behavior data and adjusts the measurement frequency of heart rate and body temperature. The sensor unit can estimate the pet's emotions and adjust the measurement frequency based on emotions. For example, if the pet is relaxed, the measurement frequency of heart rate and body temperature is set low. Also, if the pet is excited, the measurement frequency of heart rate and body temperature is set high. Furthermore, if the pet is stressed, the measurement frequency of heart rate and body temperature is set to medium. This allows adjustment of the measurement frequency according to the pet's emotions, enabling more accurate data collection.

The sensor unit can add an accelerometer to measure the pet's activity level and evaluate the condition by combining activity data with heart rate and body temperature data. The sensor unit, for example, includes an accelerometer to measure the pet's activity level. The accelerometer can measure the pet's movements in real-time. The sensor unit evaluates the condition by combining activity data with heart rate and body temperature data. For example, if the pet is actively moving, the heart rate and body temperature data are combined with activity data for evaluation. Also, if the pet is stationary, the heart rate and body temperature data are combined with activity data for evaluation. Furthermore, if the pet is sleeping, the heart rate and body temperature data are combined with activity data for evaluation. This allows more accurate evaluation of the pet's condition by combining activity data.

The sensor unit can add a sensor to measure the pet's respiratory rate and evaluate the condition by combining respiratory rate data with heart rate and body temperature data. The sensor unit, for example, includes a sensor to measure the pet's respiratory rate. The respiratory rate sensor can measure the pet's respiratory rate in real-time.

The sensor unit evaluates the condition by combining respiratory rate data with heart rate and body temperature data. For example, if the pet's respiratory rate is higher than usual, the heart rate and body temperature data are combined for evaluation. Also, if the pet's respiratory rate is lower than usual, the heart rate and body temperature data are combined for evaluation. Furthermore, if the pet's respiratory rate is irregular, the heart rate and body temperature data are combined for evaluation. This allows more accurate evaluation of the pet's condition by combining respiratory rate data.

The sensor unit can adjust the sensitivity of the sensors based on the pet's behavior data. The sensor unit, for example, collects the pet's behavior data and adjusts the sensitivity of the sensors. The sensor unit can estimate the pet's emotions and adjust the sensitivity of the sensors based on emotions. For example, if the pet is relaxed, the sensitivity of the sensors is set low. Also, if the pet is excited, the sensitivity of the sensors is set high. Furthermore, if the pet is stressed, the sensitivity of the sensors is set to medium. This allows adjustment of the sensor sensitivity according to the pet's emotions, enabling more accurate data collection.

The sensor unit can add a sensor to measure the pet's food intake and evaluate the condition by combining food intake data with heart rate and body temperature data. The sensor unit, for example, includes a sensor to measure the pet's food intake. The food intake sensor can measure the pet's food intake in real-time. The sensor unit evaluates the condition by combining food intake data with heart rate and body temperature data. For example, if the pet's food intake is more than usual, the heart rate and body temperature data are combined for evaluation. Also, if the pet's food intake is less than usual, the heart rate and body temperature data are combined for evaluation. Furthermore, if the pet's food intake is irregular, the heart rate and body temperature data are combined for evaluation. This allows more accurate evaluation of the pet's condition by combining food intake data.

The sensor unit can add a sensor to measure the pet's sleep state and evaluate the condition by combining sleep data with heart rate and body temperature data. The sensor unit, for example, includes a sensor to measure the pet's sleep state. The sleep state sensor can measure the pet's sleep state in real-time. The sensor unit evaluates the condition by combining sleep data with heart rate and body temperature data. For example, if the pet's sleep time is longer than usual, the heart rate and body temperature data are combined for evaluation. Also, if the pet's sleep time is shorter than usual, the heart rate and body temperature data are combined for evaluation. Furthermore, if the pet's sleep is irregular, the heart rate and body temperature data are combined for evaluation. This allows more accurate evaluation of the pet's condition by combining sleep data.

The collection unit can adjust the timing of data collection based on the pet's behavior data. The collection unit, for example, collects the pet's behavior data and adjusts the timing of data collection. The collection unit can estimate the pet's emotions and adjust the timing of data collection based on emotions. For example, if the pet is relaxed, the frequency of data collection is set low. Also, if the pet is excited, the frequency of data collection is set high. Furthermore, if the pet is stressed, the frequency of data collection is set to medium. This allows adjustment of the timing of data collection according to the pet's emotions, enabling more accurate data collection.

The collection unit can add a function to evaluate the reliability of data and filter out unreliable data. The collection unit, for example, evaluates the reliability of data and filters out unreliable data. The collection unit can automatically exclude unreliable data by evaluating the reliability of data. For example, the collection unit evaluates the reliability of data and collects only reliable data. Also, the collection unit can manually check unreliable data by evaluating the reliability of data. This allows filtering out unreliable data, improving data accuracy.

The collection unit can add a function to automatically detect and exclude outliers in the data. The collection unit, for example, automatically detects and excludes outliers in the data. The collection unit can automatically detect and exclude outliers in the data. For example, the collection unit automatically detects outliers in the data and manually checks them. Also, the collection unit can automatically detect and correct outliers in the data. This allows exclusion of outliers, improving data accuracy.

The collection unit can determine the priority of data to be collected based on the pet's behavior data. The collection unit, for example, collects the pet's behavior data and determines the priority of data to be collected. The collection unit can estimate the pet's emotions and determine the priority of data to be collected based on emotions. For example, if the pet is relaxed, heart rate data is prioritized for collection. Also, if the pet is excited, body temperature data is prioritized for collection. Furthermore, if the pet is stressed, respiratory rate data is prioritized for collection. This allows determination of data priority according to the pet's emotions, enabling prioritized collection of important data.

The collection unit can add a function to set the data retention period and automatically delete old data. The collection unit, for example, sets the data retention period and automatically deletes old data. The collection unit can automatically delete data that has exceeded the retention period by setting the data retention period. For example, the collection unit sets the data retention period and manually deletes data that has exceeded the retention period. Also, the collection unit can archive data that has exceeded the retention period by setting the data retention period. This allows automatic deletion of old data, making data management easier.

The collection unit can add a backup function to prevent data loss. The collection unit, for example, regularly backs up data to prevent data loss. The collection unit can regularly back up data to prevent data loss. For example, the collection unit manually backs up data to prevent data loss. Also, the collection unit can save data backups to the cloud to prevent data loss. This allows prevention of data loss through the backup function.

The analysis unit can adjust the analysis algorithm based on the pet's behavior data. The analysis unit, for example, collects the pet's behavior data and adjusts the analysis algorithm. The analysis unit can estimate the pet's emotions and adjust the analysis algorithm based on emotions. For example, if the pet is relaxed, the sensitivity of the analysis algorithm is set low. Also, if the pet is excited, the sensitivity of the analysis algorithm is set high. Furthermore, if the pet is stressed, the sensitivity of the analysis algorithm is set to medium. This allows adjustment of the analysis algorithm according to the pet's emotions, improving analysis accuracy.

The analysis unit can add a data preprocessing function to improve the accuracy of anomaly detection. The analysis unit, for example, adds a data preprocessing function to improve the accuracy of anomaly detection. The analysis unit can add a data preprocessing function to improve the accuracy of anomaly detection. For example, the analysis unit adds a data preprocessing function to remove noise from the data. Also, the analysis unit can add a data preprocessing function to complement missing values in the data. This allows improvement of anomaly detection accuracy by adding a data preprocessing function.

The analysis unit can add a function to visualize the results of anomaly detection and display them in an easy- to-understand manner for the owner. The analysis unit, for example, displays the results of anomaly detection in a graph to make it easy for the owner to understand. The analysis unit can display the results of anomaly detection in a graph to make it easy for the owner to understand. For example, the analysis unit displays the results of anomaly detection in a chart to make it easy for the owner to understand. Also, the analysis unit can display the results of anomaly detection in text to make it easy for the owner to understand. This allows visualization of anomaly detection results, making it easier for the owner to understand anomalies.

The analysis unit can adjust the display method of analysis results based on the pet's behavior data. The analysis unit, for example, collects the pet's behavior data and adjusts the display method of analysis results. The analysis unit can estimate the pet's emotions and adjust the display method of analysis results based on emotions. For example, if the pet is relaxed, detailed analysis results are displayed. Also, if the pet is excited, concise analysis results are displayed. Furthermore, if the pet is stressed, visually easy-to- understand analysis results are displayed. This allows adjustment of the display method of analysis results according to the pet's emotions, making it easier for the owner to understand the analysis results.

The analysis unit can add a function to compare the results of anomaly detection with data from other pets to evaluate the degree of anomaly. The analysis unit, for example, compares the results of anomaly detection with data from other pets to evaluate the degree of anomaly. The analysis unit can compare the results of anomaly detection with data from other pets to evaluate the degree of anomaly. For example, the analysis unit compares the results of anomaly detection with data from other pets to identify the cause of the anomaly. Also, the analysis unit can compare the results of anomaly detection with data from other pets to propose measures for the anomaly. This allows easier evaluation of the degree of anomaly by comparing with data from other pets.

The analysis unit can add a function to compare the results of anomaly detection with past data to analyze trends in anomalies. The analysis unit, for example, compares the results of anomaly detection with past data to analyze trends in anomalies. The analysis unit can compare the results of anomaly detection with past data to analyze trends in anomalies. For example, the analysis unit compares the results of anomaly detection with past data to identify the cause of the anomaly. Also, the analysis unit can compare the results of anomaly detection with past data to propose measures for the anomaly. This allows easier analysis of trends in anomalies by comparing with past data.

The notification unit can adjust the content of notifications based on the pet's behavior data. The notification unit, for example, collects the pet's behavior data and adjusts the content of notifications. The notification unit can estimate the pet's emotions and adjust the content of notifications based on emotions. For example, if the pet is relaxed, detailed notification content is provided. Also, if the pet is excited, concise notification content is provided. Furthermore, if the pet is stressed, visually easy-to-understand notification content is provided. This allows adjustment of notification content according to the pet's emotions, making it easier for the owner to understand the notification content.

The notification unit can add a function to set the urgency of notifications and change the notification method according to the urgency. The notification unit, for example, sets the urgency of notifications and changes the notification method according to the urgency. The notification unit can set the urgency of notifications and change the notification method according to the urgency. For example, if the urgency is high, the notification unit uses smartphone push notifications for immediate notification. Also, if the urgency is medium, the notification unit can notify via email. Furthermore, if the urgency is low, the notification unit can display notifications in the app's notification center. This allows changing the notification method according to the urgency, enabling the owner to respond quickly.

The notification unit can add a function to save notification history and allow reference to past notification content. The notification unit, for example, saves notification history and allows reference to past notification content. The notification unit can save notification history and allow reference to past notification content. For example, the notification unit saves notification history and displays past notification content in a list. Also, the notification unit can save notification history and allow searching for specific notification content. Furthermore, the notification unit can save notification history and display notification content in chronological order. This allows easier reference to past notification content by saving notification history.

The notification unit can adjust the timing of notifications based on the pet's behavior data. The notification unit, for example, collects the pet's behavior data and adjusts the timing of notifications. The notification unit can estimate the pet's emotions and adjust the timing of notifications based on emotions. For example, if the pet is relaxed, the timing of notifications is delayed. Also, if the pet is excited, the timing of notifications is advanced. Furthermore, if the pet is stressed, the timing of notifications is set to medium. This allows adjustment of the timing of notifications according to the pet's emotions, enabling the owner to receive notifications at the appropriate timing.

The notification unit can add a customization function to change the notification content according to the owner's preferences. The notification unit, for example, adds a customization function to change the notification content according to the owner's preferences. The notification unit can add a customization function to change the notification content according to the owner's preferences. For example, if the owner prefers detailed notifications, the notification unit provides detailed notification content. Also, if the owner prefers concise notifications, the notification unit provides concise notification content. Furthermore, if the owner prefers visual notifications, the notification unit provides notification content including graphs and charts. This allows the owner to receive notification content according to their preferences through the customization function.

The notification unit can add a function to select the language of notifications and provide notifications in multiple languages. The notification unit, for example, adds a function to select the language of notifications and provides notifications in multiple languages. The notification unit can add a function to select the language of notifications and provide notifications in multiple languages. For example, the notification unit automatically sets the notification language based on the language settings of the owner's device. Also, if the owner uses multiple languages, the notification unit can provide a language switching function. Furthermore, if the owner selects a specific language, the notification unit provides notifications in that language. This allows the owner to receive notifications in the desired language through the function to select the notification language.

The referral unit can adjust the criteria for selecting animal hospitals to be introduced based on the pet's behavior data. The referral unit, for example, collects the pet's behavior data and adjusts the criteria for selecting animal hospitals to be introduced. The referral unit can estimate the pet's emotions and adjust the criteria for selecting animal hospitals to be introduced based on emotions. For example, if the pet is relaxed, a regular animal hospital is introduced. Also, if the pet is excited, an animal hospital capable of emergency response is introduced. Furthermore, if the pet is stressed, an animal hospital specializing in stress reduction is introduced. This allows adjustment of the criteria for selecting animal hospitals according to the pet's emotions, enabling the introduction of the optimal animal hospital.

The referral unit can add a function to collect evaluation information of animal hospitals and prioritize the introduction of highly rated hospitals. The referral unit, for example, collects evaluation information of animal hospitals and prioritizes the introduction of highly rated hospitals. The referral unit can collect evaluation information of animal hospitals and prioritize the introduction of highly rated hospitals. For example, the referral unit collects evaluation information of animal hospitals and prioritizes the introduction of highly rated hospitals. Also, the referral unit can collect evaluation information of animal hospitals and exclude low-rated hospitals. Furthermore, the referral unit can collect evaluation information of animal hospitals and display highly rated hospitals in a ranking format. This allows prioritization of highly rated hospitals for introduction, making it easier for the owner to choose a reliable hospital.

The referral unit can add a function to select the optimal hospital based on the medical departments and specialties of animal hospitals. The referral unit, for example, selects the optimal hospital based on the medical departments and specialties of animal hospitals. The referral unit can select the optimal hospital based on the medical departments and specialties of animal hospitals. For example, the referral unit selects the optimal hospital based on the medical departments of animal hospitals. Also, the referral unit can select the optimal hospital based on the specialties of animal hospitals. Furthermore, the referral unit can combine the medical departments and specialties of animal hospitals to select the optimal hospital. This allows selection of the optimal hospital based on medical departments and specialties, enabling the introduction of a hospital suitable for the pet's symptoms.

The referral unit can determine the priority of animal hospitals to be introduced based on the pet's behavior data. The referral unit, for example, collects the pet's behavior data and determines the priority of animal hospitals to be introduced. The referral unit can estimate the pet's emotions and determine the priority of animal hospitals to be introduced based on emotions. For example, if the pet is relaxed, a regular animal hospital is prioritized for introduction. Also, if the pet is excited, an animal hospital capable of emergency response is prioritized for introduction. Furthermore, if the pet is stressed, an animal hospital specializing in stress reduction is prioritized for introduction. This allows determination of the priority of animal hospitals according to the pet's emotions, enabling quick introduction of the optimal hospital.

The referral unit can add a function to check the reservation status of animal hospitals and introduce hospitals that are easy to book. The referral unit, for example, checks the reservation status of animal hospitals and introduces hospitals that are easy to book. The referral unit can check the reservation status of animal hospitals and introduce hospitals that are easy to book. For example, the referral unit checks the reservation status of animal hospitals and introduces hospitals that are easy to book. Also, the referral unit can check the reservation status of animal hospitals and exclude hospitals that are difficult to book. Furthermore, the referral unit can check the reservation status of animal hospitals and display hospitals that are easy to book in a ranking format. This allows introduction of hospitals that are easy to book, enabling the owner to quickly make a reservation.

The referral unit can add a function to provide location information of animal hospitals and introduce hospitals close to the owner's residence. The referral unit, for example, provides location information of animal hospitals and introduces hospitals close to the owner's residence. The referral unit can provide location information of animal hospitals and introduce hospitals close to the owner's residence. For example, the referral unit provides location information of animal hospitals and introduces hospitals close to the owner's residence. Also, the referral unit can provide location information of animal hospitals and exclude hospitals far from the owner's residence. Furthermore, the referral unit can provide location information of animal hospitals and display hospitals close to the owner's residence in a ranking format. This allows introduction of hospitals close to the owner's residence, enabling the owner to quickly access the hospital.

The system according to the embodiment is not limited to the examples described above, and various modifications are possible, for example, as follows.

The pet monitoring system can further include a sensor to measure the pet's food intake. The food intake sensor measures the pet's food intake in real-time and sends the data to the collection unit. The analysis unit can evaluate the pet's condition by combining food intake data with heart rate and body temperature data. For example, if the pet's food intake is more than usual, the heart rate and body temperature data are combined for evaluation. Also, if the pet's food intake is less than usual, the heart rate and body temperature data are combined for evaluation. Furthermore, if the pet's food intake is irregular, the heart rate and body temperature data are combined for evaluation. This allows more accurate evaluation of the pet's condition by combining food intake data.

The pet monitoring system can further include a function to adjust the sensitivity of sensors based on the pet's behavior data. The sensor unit collects the pet's behavior data and estimates emotions. For example, if the pet is relaxed, the sensitivity of the sensors is set low. Also, if the pet is excited, the sensitivity of the sensors is set high. Furthermore, if the pet is stressed, the sensitivity of the sensors is set to medium. This allows adjustment of the sensor sensitivity according to the pet's emotions, enabling more accurate data collection.

The pet monitoring system can further include a sensor to measure the pet's sleep state. The sleep state sensor measures the pet's sleep state in real-time and sends the data to the collection unit. The analysis unit can evaluate the pet's condition by combining sleep data with heart rate and body temperature data. For example, if the pet's sleep time is longer than usual, the heart rate and body temperature data are combined for evaluation. Also, if the pet's sleep time is shorter than usual, the heart rate and body temperature data are combined for evaluation. Furthermore, if the pet's sleep is irregular, the heart rate and body temperature data are combined for evaluation. This allows more accurate evaluation of the pet's condition by combining sleep data.

The pet monitoring system can further include a sensor to measure the pet's respiratory rate. The respiratory rate sensor measures the pet's respiratory rate in real-time and sends the data to the collection unit. The analysis unit can evaluate the pet's condition by combining respiratory rate data with heart rate and body temperature data. For example, if the pet's respiratory rate is higher than usual, the heart rate and body temperature data are combined for evaluation. Also, if the pet's respiratory rate is lower than usual, the heart rate and body temperature data are combined for evaluation. Furthermore, if the pet's respiratory rate is irregular, the heart rate and body temperature data are combined for evaluation. This allows more accurate evaluation of the pet's condition by combining respiratory rate data.

The pet monitoring system can further include a function to adjust the timing of data collection based on the pet's behavior data. The collection unit collects the pet's behavior data and estimates emotions. For example, if the pet is relaxed, the frequency of data collection is set low. Also, if the pet is excited, the frequency of data collection is set high. Furthermore, if the pet is stressed, the frequency of data collection is set to medium. This allows adjustment of the timing of data collection according to the pet's emotions, enabling more accurate data collection.

The pet monitoring system can further include a function to adjust the content of notifications based on the pet's behavior data. The notification unit collects the pet's behavior data and estimates emotions. For example, if the pet is relaxed, detailed notification content is provided. Also, if the pet is excited, concise notification content is provided. Furthermore, if the pet is stressed, visually easy-to-understand notification content is provided. This allows adjustment of notification content according to the pet's emotions, making it easier for the owner to understand the notification content.

The pet monitoring system can further include a function to adjust the timing of notifications based on the pet's behavior data. The notification unit collects the pet's behavior data and estimates emotions. For example, if the pet is relaxed, the timing of notifications is delayed. Also, if the pet is excited, the timing of notifications is advanced. Furthermore, if the pet is stressed, the timing of notifications is set to medium. This allows adjustment of the timing of notifications according to the pet's emotions, enabling the owner to receive notifications at the appropriate timing.

The pet monitoring system can further include a function to adjust the analysis algorithm based on the pet's behavior data. The analysis unit collects the pet's behavior data and estimates emotions. For example, if the pet is relaxed, the sensitivity of the analysis algorithm is set low. Also, if the pet is excited, the sensitivity of the analysis algorithm is set high. Furthermore, if the pet is stressed, the sensitivity of the analysis algorithm is set to medium. This allows adjustment of the analysis algorithm according to the pet's emotions, improving analysis accuracy.

The pet monitoring system can further include a function to determine the priority of data to be collected based on the pet's behavior data. The collection unit collects the pet's behavior data and estimates emotions. For example, if the pet is relaxed, heart rate data is prioritized for collection. Also, if the pet is excited, body temperature data is prioritized for collection. Furthermore, if the pet is stressed, respiratory rate data is prioritized for collection. This allows determination of data priority according to the pet's emotions, enabling prioritized collection of important data.

The pet monitoring system can further include a function to adjust the criteria for selecting animal hospitals to be introduced based on the pet's behavior data. The referral unit collects the pet's behavior data and estimates emotions. For example, if the pet is relaxed, a regular animal hospital is introduced. Also, if the pet is excited, an animal hospital capable of emergency response is introduced. Furthermore, if the pet is stressed, an animal hospital specializing in stress reduction is introduced. This allows adjustment of the criteria for selecting animal hospitals according to the pet's emotions, enabling the introduction of the optimal animal hospital.

The following is a brief explanation of the process flow in Example 2 of the Embodiment.

Step 1: The sensor unit measures the pet's heart rate and body temperature. For example, the sensor unit can include a heart rate sensor attached to a collar and a body temperature sensor installed in a cage.

Step 2: The collection unit collects data measured by the sensor unit. For example, the collection unit can collect heart rate and body temperature data in real-time.

Step 3: The analysis unit analyzes the data collected by the collection unit and evaluates the pet's condition. For example, the analysis unit can detect abnormalities using a machine learning algorithm. The machine learning algorithm learns the normal range based on past data and determines an anomaly when data exceeding that range is detected.

Step 4: The notification unit notifies the owner if an abnormality is detected by the analysis unit. For example, the notification unit can notify in real-time through a smartphone app. Also, the notification unit can notify via email.

Step 5: The referral unit introduces the optimal animal hospital based on the information notified by the notification unit. For example, the referral unit can select the optimal animal hospital according to the pet's symptoms and introduce it to the owner.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the multiple elements including the aforementioned sensor unit, collection unit, analysis unit, notification unit, and referral unit is implemented in at least one of, for example, the smart device 14 and the data processing device 12. For example, the sensor unit includes a heart rate sensor attached to a collar and a body temperature sensor installed in a cage as part of the smart device 14. The collection unit is implemented by the control unit 46A of the smart device 14 and collects heart rate and body temperature data in real-time. The analysis unit is implemented by the specific processing unit 290 of the data processing device 12 and detects abnormalities using a machine learning algorithm. The notification unit is implemented by the control unit 46A of the smart device 14 and notifies the owner through a smartphone app or email. The referral unit is implemented by the specific processing unit 290 of the data processing device 12 and selects the optimal animal hospital according to the pet's symptoms and introduces it to the owner. The correspondence between each unit and the device or control unit is not limited to the examples described above, and various modifications are possible.

### Second Embodiment

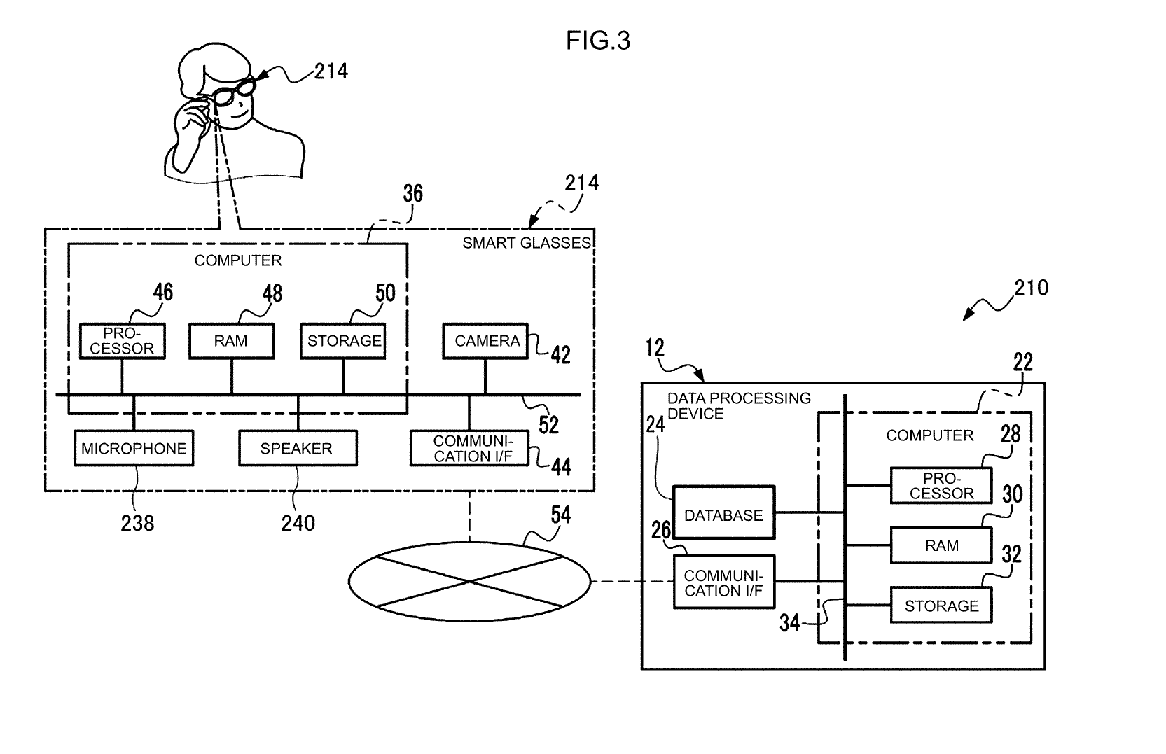

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal- Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

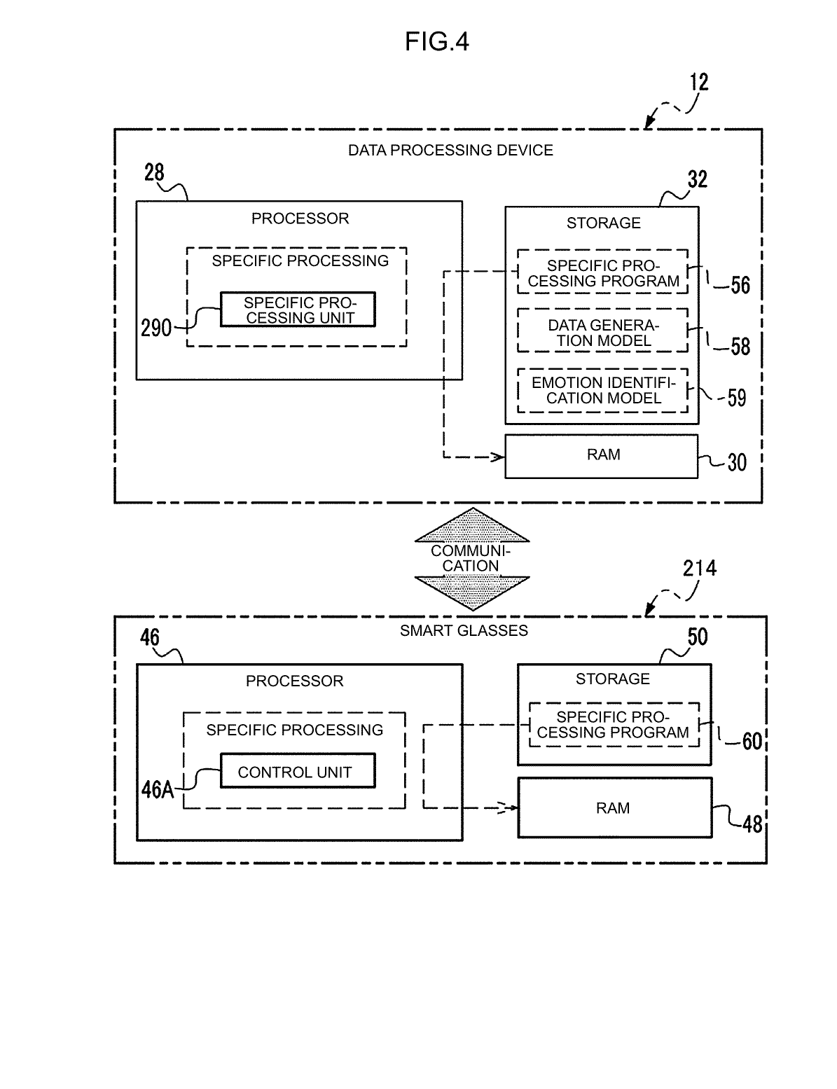

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVIV), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the multiple elements including the aforementioned sensor unit, collection unit, analysis unit, notification unit, and referral unit is implemented in at least one of, for example, the smart glasses 214 and the data processing device 12. For example, the sensor unit includes a heart rate sensor attached to a collar and a body temperature sensor installed in a cage as part of the smart glasses 214. The collection unit is implemented by the control unit 46A of the smart glasses 214 and collects heart rate and body temperature data in real-time. The analysis unit is implemented by the specific processing unit 290 of the data processing device 12 and detects abnormalities using a machine learning algorithm. The notification unit is implemented by the control unit 46A of the smart glasses 214 and notifies the owner through a smartphone app or email. The referral unit is implemented by the specific processing unit 290 of the data processing device 12 and selects the optimal animal hospital according to the pet's symptoms and introduces it to the owner. The correspondence between each unit and the device or control unit is not limited to the examples described above, and various modifications are possible.

### Third Embodiment

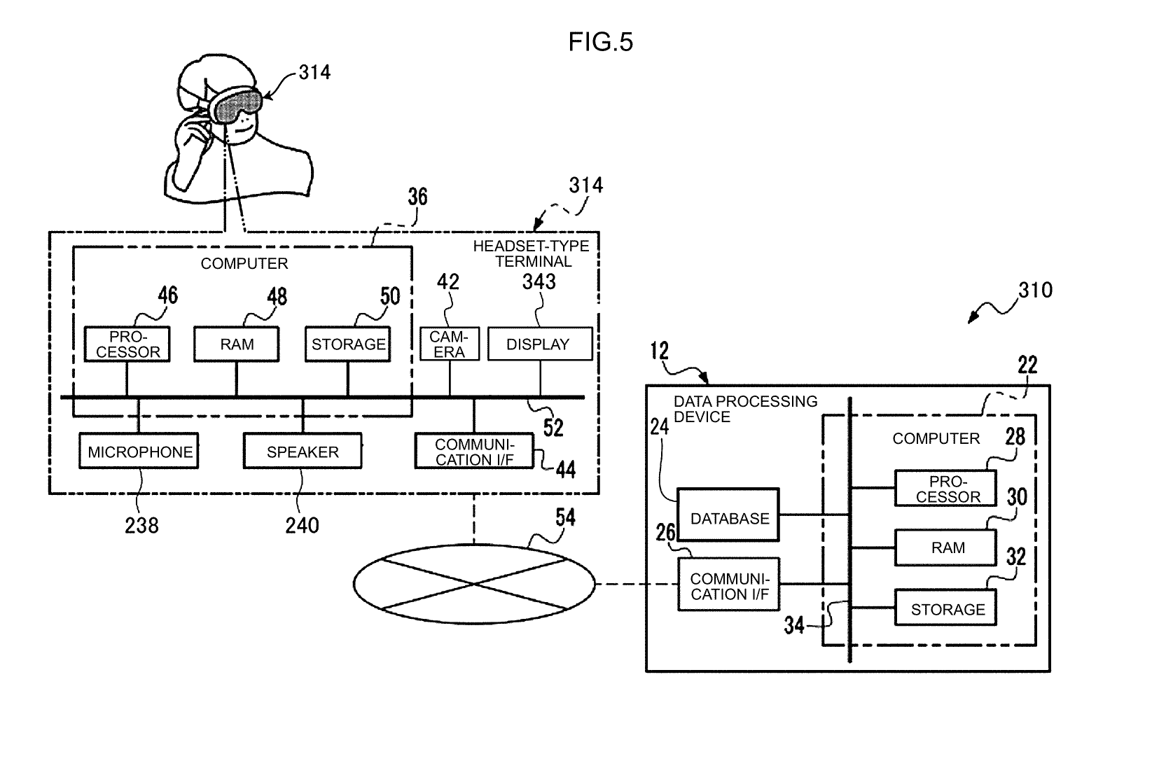

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal- Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

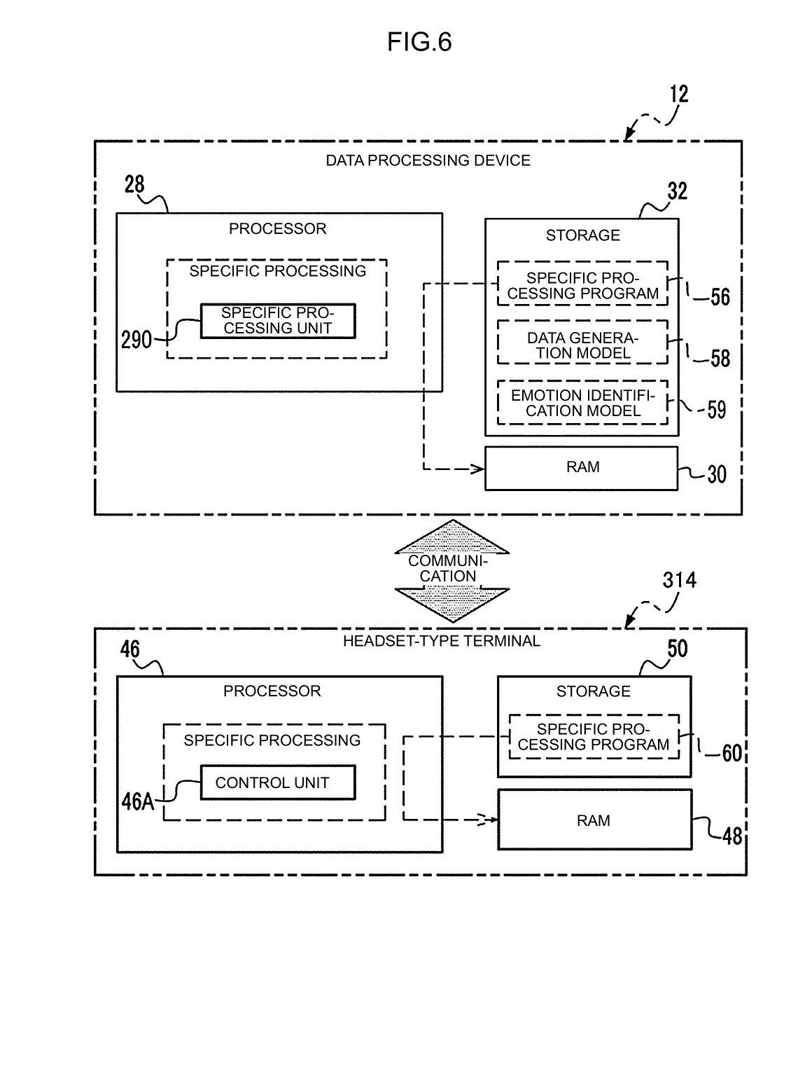

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVIV), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.Each of the multiple elements including the aforementioned sensor unit, collection unit, analysis unit, notification unit, and referral unit is implemented in at least one of, for example, the headset-type terminal 314 and the data processing device 12. For example, the sensor unit includes a heart rate sensor attached to a collar and a body temperature sensor installed in a cage as part of the headset-type terminal 314. The collection unit is implemented by the control unit 46A of the headset-type terminal 314 and collects heart rate and body temperature data in real-time. The analysis unit is implemented by the specific processing unit 290 of the data processing device 12 and detects abnormalities using a machine learning algorithm. The notification unit is implemented by the control unit 46A of the headset-type terminal 314 and notifies the owner through a smartphone app or email. The referral unit is implemented by the specific processing unit 290 of the data processing device 12 and selects the optimal animal hospital according to the pet's symptoms and introduces it to the owner. The correspondence between each unit and the device or control unit is not limited to the examples described above, and various modifications are possible.

### Fourth Embodiment

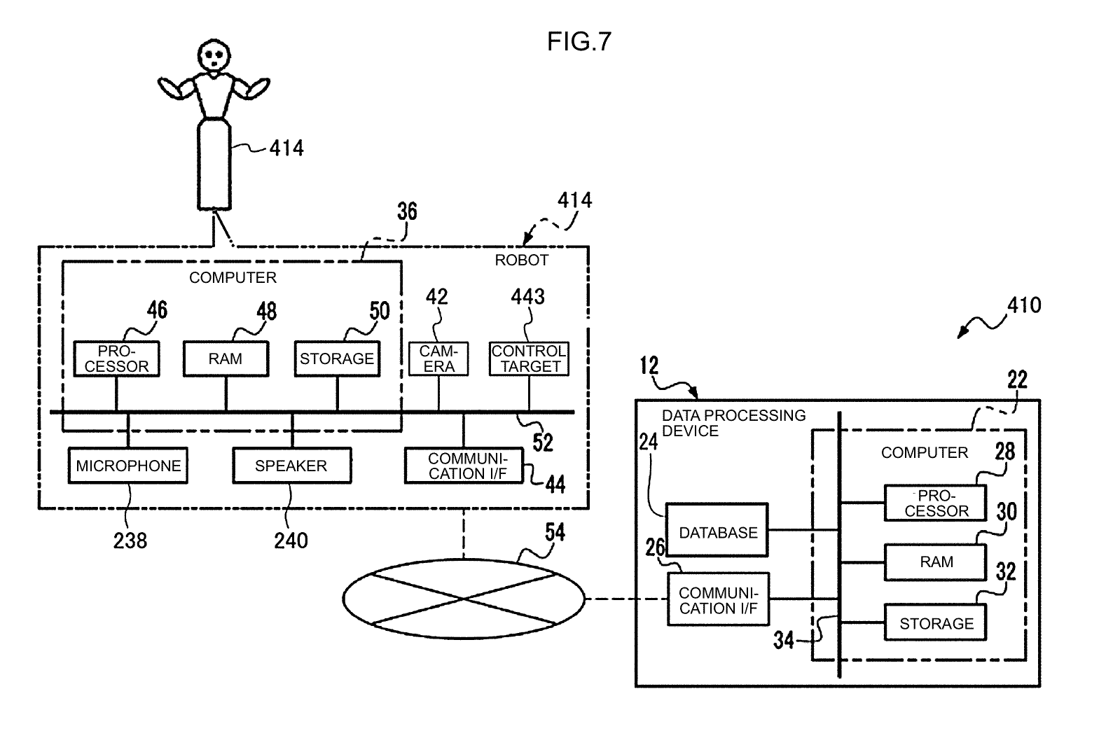

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

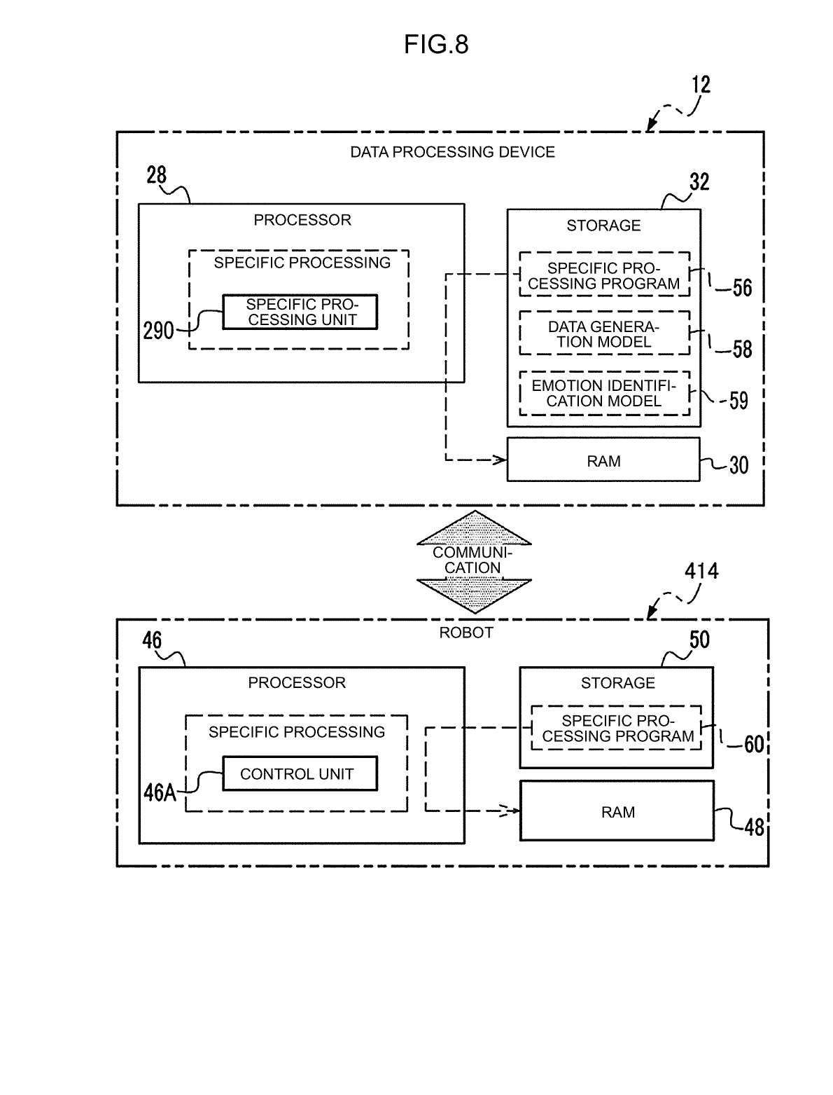

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVIV), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the multiple elements including the aforementioned sensor unit, collection unit, analysis unit, notification unit, and referral unit is implemented in at least one of, for example, the robot 414 and the data processing device 12. For example, the sensor unit includes a heart rate sensor attached to a collar and a body temperature sensor installed in a cage as part of the robot 414. The collection unit is implemented by the control unit 46A of the robot 414 and collects heart rate and body temperature data in real-time. The analysis unit is implemented by the specific processing unit 290 of the data processing device 12 and detects abnormalities using a machine learning algorithm. The notification unit is implemented by the control unit 46A of the robot 414 and notifies the owner through a smartphone app or email. The referral unit is implemented by the specific processing unit 290 of the data processing device 12 and selects the optimal animal hospital according to the pet's symptoms and introduces it to the owner. The correspondence between each unit and the device or control unit is not limited to the examples described above, and various modifications are possible.

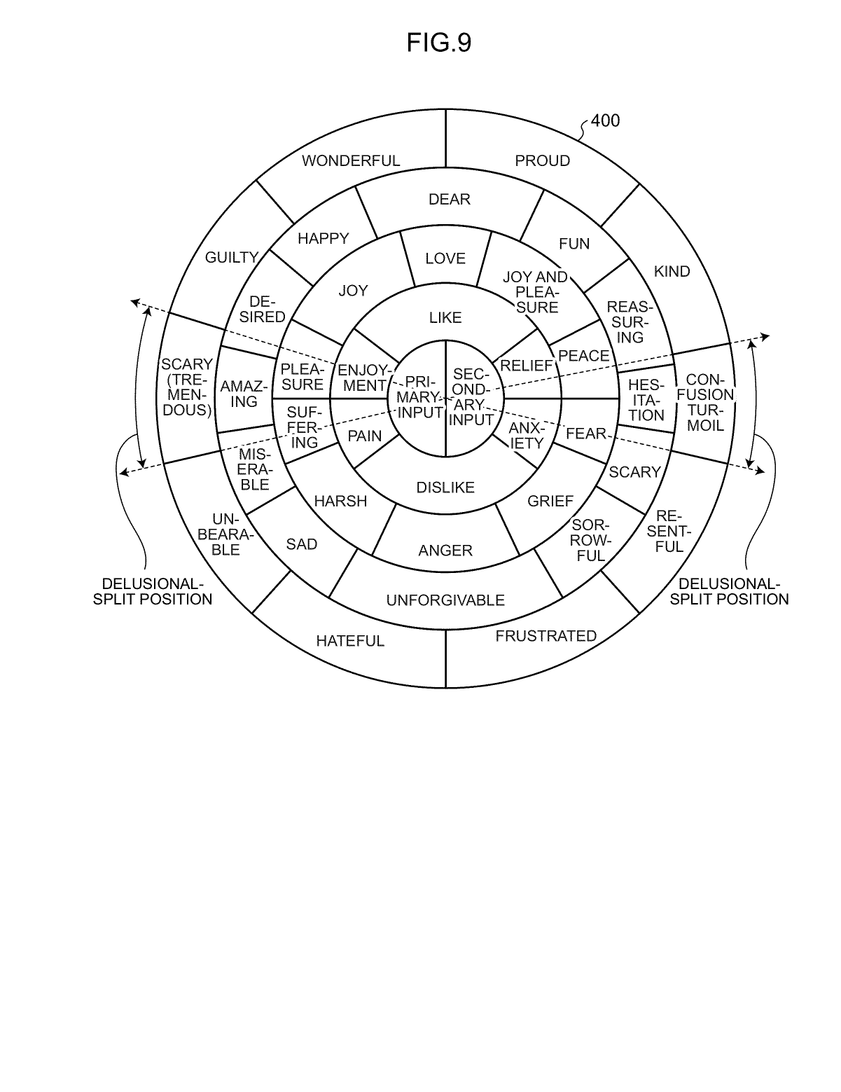

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, "pleasant" emotions are arranged, and on the lower side, "unpleasant" emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called "reactions," where sensations take precedence, are aligned. Additionally, in the right half of the emotion map, emotions belonging to the domain called "situations," where situational recognition takes precedence, are aligned.

In the emotion map, two emotions that promote learning are defined. One is a negative emotion around "repentance" or "reflection" on the situation side. In other words, when a negative emotion arises in the robot, like "I never want to feel this way again" or "I don't want to be scolded again." The other is an emotion around "desire" on the reaction side, which is positive. In other words, it is a positive feeling like "I want more" or "I want to know more."

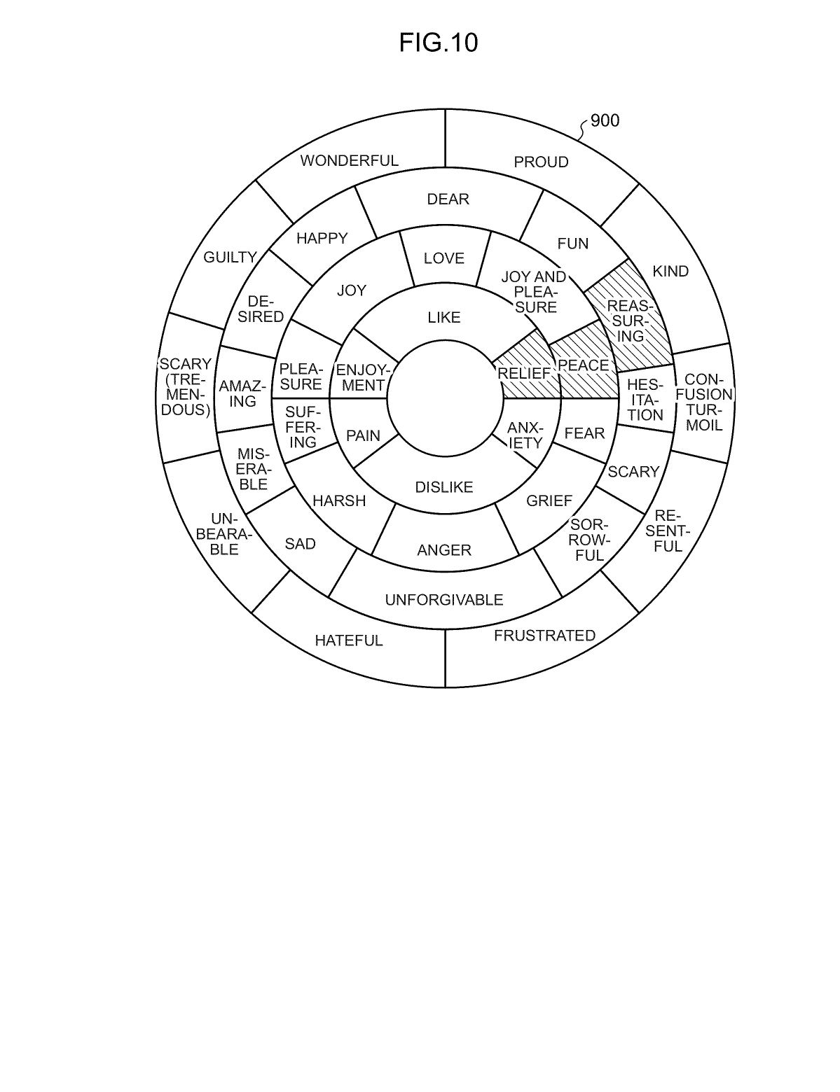

The emotion identification model 59 inputs user input into a pre-learned neural network, acquires emotion values indicating each emotion shown in the emotion map 400, and determines the user's emotions. This neural network is pre- learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like "reassured," "calm," and "confident" have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The system according to the embodiments is capable of monitoring a pet's condition in real-time and detect abnormalities early to take appropriate action.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### Additional Note 1

A system including:

a sensor unit that measures a heart rate and a body temperature of a pet;

a collection unit that collects data measured by the sensor unit;

an analysis unit that analyzes the data collected by the collection unit, and evaluates a pet's condition;

a notification unit that notifies an owner if an abnormality is detected by the analysis unit; and

a referral unit that introduces an animal hospital based on the information notified by the notification unit.

### Additional Note 2

The system according to Additional Note 1, wherein the sensor unit includes a heart rate sensor attached to a collar.

### Additional Note 3

The system according to Additional Note 1, wherein the sensor unit includes a body temperature sensor installed in a cage.

### Additional Note 4

The system according to Additional Note 1, wherein the analysis unit detects an abnormality using a machine learning algorithm.

### Additional Note 5

The system according to Additional Note 1, wherein the notification unit notifies in real-time through a smartphone app.

### Additional Note 6

The system according to Additional Note 1, wherein the notification unit notifies via an email.

### Additional Note 7

The system according to Additional Note 1, wherein the sensor unit adjusts a measurement frequency of a heart rate and a body temperature based on pet's behavior data.

### Additional Note 8

The system according to Additional Note 1, wherein the sensor unit adds an accelerometer to measure a pet's activity level, and evaluates a condition by combining activity data with a heart rate and a body temperature data.

### Additional Note 9

The system according to Additional Note 1, wherein the sensor unit adds a sensor to measure a pet's respiratory rate, and evaluates a condition by combining respiratory rate data with heart rate and body temperature data.

### Additional Note 10

The system according to Additional Note 1, wherein the sensor unit adjusts a sensitivity of a sensor based on pet's behavior data.

### Additional Note 11

The system according to Additional Note 1, wherein the sensor unit adds a sensor to measure a pet's food intake, and evaluates a condition by combining food intake data with a heart rate and a body temperature data.

### Additional Note 12

The system according to Additional Note 1, wherein the sensor unit adds a sensor to measure a pet's sleep state, and evaluates a condition by combining sleep data with a heart rate and a body temperature data.

### Additional Note 13

The system according to Additional Note 1, wherein the collection unit adjusts a timing of data collection based on pet's behavior data.

### Additional Note 14

The system according to Additional Note 1, wherein the collection unit adds a function to evaluate reliability of data and filters out unreliable data.

### Additional Note 15

The system according to Additional Note 1, wherein the collection unit adds a function to automatically detect and exclude outliers in the data.

### Additional Note 16

The system according to Additional Note 1, wherein the collection unit determines a priority of data to be collected based on pet's behavior data.

### Additional Note 17

The system according to Additional Note 1, wherein the collection unit adds a function to set a data retention period and automatically deletes old data.

### Additional Note 18

The system according to Additional Note 1, wherein the collection unit adds a backup function to prevent data loss.

### Additional Note 19

The system according to Additional Note 1, wherein the analysis unit adjusts the analysis algorithm based on the pet's behavior data.

### Additional Note 20

The system according to Additional Note 1, wherein the analysis unit adds a data preprocessing function to improve accuracy of anomaly detection.

### Additional Note 21

The system according to Additional Note 1, wherein the analysis unit adds a function to visualize a result of anomaly detection and display them in an easy-to-understand manner for the owner.

### Additional Note 22

The system according to Additional Note 1, wherein the analysis unit adjusts a display method of an analysis based on the pet's behavior data.

### Additional Note 23

The system according to Additional Note 1, wherein the analysis unit adds a function to compare a result of anomaly detection with data from another pet to evaluate a degree of anomaly.

### Additional Note 24

The system according to Additional Note 1, wherein the analysis unit adds a function to compare a result of anomaly detection with past data to analyze a trend in anomalies.

### Additional Note 25

The system according to Additional Note 1, wherein the notification unit adjusts a content of notification based on pet's behavior data.

### Additional Note 26

The system according to Additional Note 1, wherein the notification unit adds a function to set urgency of a notification, and changes the notification method according to an urgency.

### Additional Note 27

The system according to Additional Note 1, wherein the notification unit adds a function to save notification history, and allows reference to a past notification content.

### Additional note 28

The system according to Additional Note 1, wherein the notification unit adjusts a timing of notification based on pet's behavior data.

### Additional Note 29

The system according to Additional Note 1, wherein the notification unit adds a customization function to change the notification content according to owner's preferences.

### Additional Note 30

The system according to Additional Note 1, wherein the notification unit adds a function to select a language of a notification, and provides a notification in multiple languages.

### Additional Note 31

The system according to Additional Note 1, wherein the referral unit adjusts a criteria for selecting an animal hospital to be introduced based on pet's behavior data.

### Additional Note 32

The system according to Additional Note 1, wherein the referral unit collects evaluation information of an animal hospital, and adds a function to prioritize introduction of a highly rated hospital.

### Additional Note 33

The system according to Additional Note 1, wherein the referral unit adds a function to select an optimal hospital based on a medical department and a specialty of an animal hospital.

### Additional Note 34

The system according to Additional Note 1, wherein the referral unit determines a priority of an animal hospital to be introduced based on pet's behavior data.

### Additional Note 35

The system according to Additional Note 1, wherein the referral unit adds a function to check a reservation status of an animal hospital, and introduces a hospital that is easy to book.

### Additional Note 36

The system according to Additional Note 1, wherein the referral unit provides location information of an animal hospital, and introduces a hospital close to an owner's residence.

1. A system comprising:a sensor unit that measures a heart rate and a body temperature of a pet;a collection unit that collects data measured by the sensor unit;an analysis unit that analyzes the data collected by the collection unit, and evaluates a pet's condition;a notification unit that notifies an owner if an abnormality is detected by the analysis unit; anda referral unit that introduces an animal hospital based on information notified by the notification unit.

2. The system according to claim 1, wherein the sensor unit includes a heart rate sensor attached to a collar.

3. The system according to claim 1, wherein the sensor unit includes a body temperature sensor installed in a cage.

4. The system according to claim 1, wherein the analysis unit detects an abnormality by using a machine learning algorithm.

5. The system according to claim 1, wherein the notification unit notifies in real-time through a smartphone app.

6. The system according to claim 1, wherein the notification unit notifies via an email.

7. The system according to claim 1, wherein the sensor unit adjusts a measurement frequency of a heart rate and a body temperature based on pet's behavior data.

8. The system according to claim 1, wherein the sensor unit adds an accelerometer to measure a pet's activity level, and evaluates a condition by combining activity data with heart rate and body temperature data.

9. The system according to claim 1, wherein the sensor unit adds a sensor to measure a pet's respiratory rate, and evaluates a condition by combining respiratory rate data with heart rate and body temperature data.

10. The system according to claim 1, wherein the sensor unit adjusts a sensitivity of a sensor based on pet's behavior data.
